(19) United States
(12) Patent Application Publication
(10) Pub. No.: US 2016/0155158 A1
(43) Pub. Date: Jun. 2, 2016

(54) INFORMATION DISTRIBUTION SERVER AND INFORMATION DISTRIBUTION METHOD

(71) Applicant: TOSHIBA TEC KABUSHIKI KAISHA, Tokyo (JP)

(72) Inventor: Kenji Shimizu, Shizuoka-ken (JP)

(21) Appl. No.: 15/015,365

(22) Filed: Feb. 4, 2016

Related U.S. Application Data
(62) Division of application No. 13/968,509, filed on Aug. 16, 2013.

(30) Foreign Application Priority Data
Sep. 5, 2012 (JP) 2012-194762

(51) Int. Cl. G06Q 30/02

(52) U.S. Cl. CPC G06Q 30/0276; G06Q 30/0242; G06Q 30/0264

(57) ABSTRACT

An information distribution server includes a content sending unit, a measurement data reception unit, an advertisement effect processing unit, an effect measurement database, a data input unit, a template selection unit and a content generation unit. The measurement data reception unit receives measurement information for measuring the advertisement effect of the content data during a content distribution period. The advertisement effect processing unit determines whether or not advertisement effect is high with use of the measurement data collected by carrying out the content distribution, where the content distribution is carried out by changing a screen template in a same setting. The effect measurement database stores the determined advertisement effect together with measurement information for each screen template. The template selection unit preferentially selects a screen template having a high advertisement effect with reference to the effect measurement database based on the input project information. The content generation unit generates content data using the selected screen template and registers the generated content data in a schedule.

### CROSS-REFERENCE TO RELATED APPLICATIONS

This application is a Division of application Ser. No. 13/968,509 filed on Aug. 16, 2013; the entire contents of which are incorporated herein by reference.

The present application is based upon and claims the benefit of priorities from Japanese Patent Application No. 2012-194762, filed Sep. 5, 2012, the entire contents of which are incorporated herein by reference.

### FIELD

Embodiments described herein relate to an information distribution server and information distribution method.

### BACKGROUND

As a structure for presenting content such as an advertisement, an event and a notice to a non-specific person, there is known an information display system for displaying and regenerating digitalized content information on a signage terminal such as a display device, that is, the so-called digital signage system.

### BRIEF DESCRIPTION OF THE DRAWINGS

FIG. 1 is a block diagram illustrating schematic constitution of a signage system according to an embodiment;

FIG. 2 is an external front view of a signage terminal;

FIG. 3 is a block diagram illustrating schematic constitution of the signage terminal;

FIG. 4 is a block diagram illustrating schematic constitution of an information distribution server;

FIG. 5 is a diagram illustrating constitution of data stored in a template database;

FIG. 6 is a schematic diagram roughly illustrating a screen template for bargain sale;

FIG. 7 is a diagram illustrating constitution of data stored in a content database;

FIG. 8 is a diagram illustrating constitution of data stored in an effect measurement database;

FIG. 9 is a block diagram illustrating functional components of the information distribution server and the signage terminal;

FIG. 10 is a diagram illustrating an application example of different screen templates; and

FIG. 11 is a flowchart illustrating a flow of processing actions in the information distribution server.

### DETAILED DESCRIPTION

In accordance with an embodiment, an information distribution server includes a content sending unit, a measurement data reception unit, an advertisement effect processing unit, an effect measurement database, a data input unit, a template selection unit and a content generation unit. The content sending unit is configured to send content data to a signage terminal according to a registered schedule. The effect measurement data reception unit is configured to receive, during a content distribution period, measurement information for measuring the advertisement effect of the content data sent by the content sending unit. The advertisement effect processing unit is configured to determine whether or not advertisement effect is high with use of the measurement data collected by carrying out the content distribution, where the content distribution is carried out by changing a screen template in a same setting. The effect measurement database is configured to store the advertisement effect determined by the advertisement effect processing unit together with the measurement information for each screen template used in content data. The data input unit is configured to input specified project information. The template selection unit is configured to preferentially select a screen template having a high advertisement effect with reference to the effect measurement database based on the project information input by the data input unit. The content generation unit is configured to generate the content data and register the generated content data in the schedule using the screen template selected by the template selection unit.

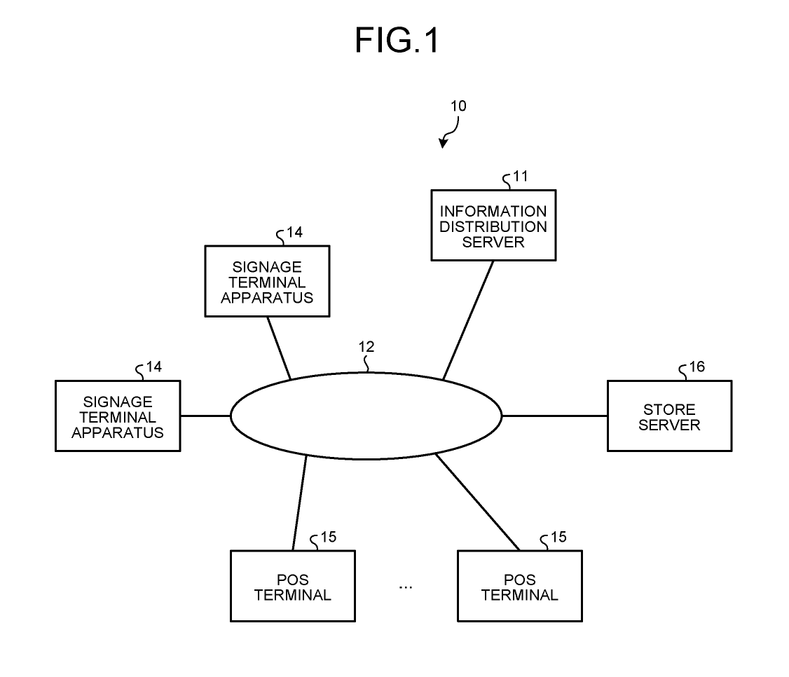

FIG. 1 is a block diagram illustrating the schematic constitution of a signage system 10 according to the present embodiment. The description below is description when the signage system 10 serving as an information display system according to the present embodiment is arranged in a mass retail store.

The main body of the signage system 10 described in the embodiment comprises an information distribution server 11 and a plurality of signage terminals 14. In addition, the signage system 10 comprises a plurality of POS (Point Of Sale) terminals 15 and a store server 16 serving as an external apparatus.

The information distribution server 11 is connected with the signage terminals 14 through a communication network 12 such as an internal LAN (Local Area Network) to distribute content data such as the advertisement information or event information of a commodity to the signage terminals 14 or to acquire content data by accessing the signage terminals 14.

The signage terminals 14 are arranged in the premises (such as commodity sales floor selling commodities or an entrance of a store) of a store and regenerates and displays the content data received or acquired from the information distribution server 11 through the communication network 12.

The store server 16 carries out a sales management based on POS master data such as a commodity code, price information, commodity name information, bargain price information and bargain sale period information and the sales data sent from a POS terminal 15.

Further, the store server 16 outputs the POS master data such as a commodity code, price information, commodity name information, bargain price information and bargain sale period information to the information distribution server 11. Particularly, the store server 16 outputs the bargain sale information to the information distribution server 11 if the bargain sale information containing a commodity code, bargain price information and bargain sale period information and content distribution time and the like is reregistered or updated.

Each POS terminal 15 is arranged in the checkout place of a store to carry out a transmission/reception of POS master data (commodity code, price information, commodity name information, bargain price information and bargain sale period information) with the store server 16 through the communication network 12. Each POS terminal 15 carries out registration and settlement for the commodities purchased by a customer by using the POS master data.

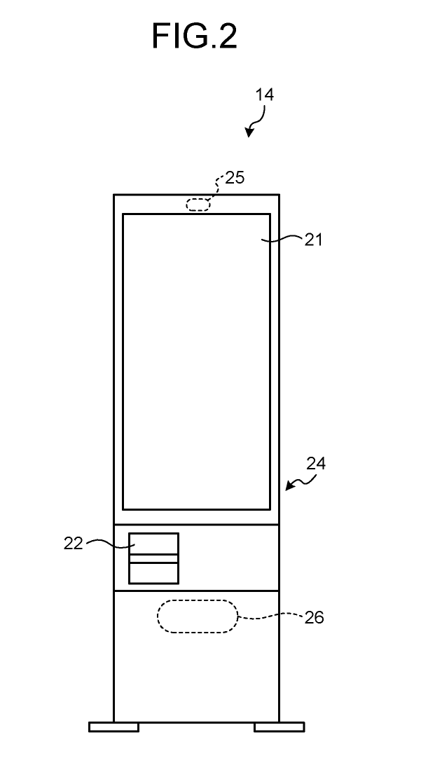

Next, the signage terminal 14 is described. FIG. 2 is an external front view of the signage terminal 14. As shown in FIG. 2, the signage terminal 14 comprises a display unit 21 including a liquid crystal display or plasma display, a printer unit 22 for printing and issuing various tickets and coupons and a housing section 24 for holding the display unit 21 and the printer unit 22.

A camera unit 25 is arranged in the upper portion of the housing section 24 to capture a person to carry out image recognition or to specify the age group of the person or control the type of the distributed information. Further, a speaker unit 26 for outputting various sounds such as EGM or advertisement sound is arranged in the lower portion of the housing section 24. Further, the processing of image recognition and the like may be carried out by a higher-level server such as the information distribution server 11 but not by the signage terminal 14.

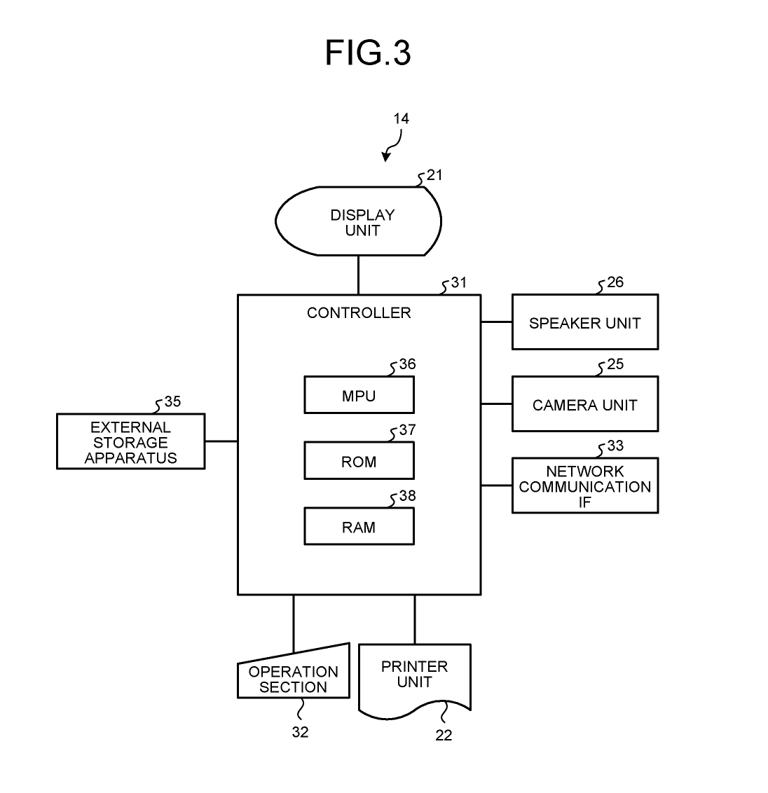

FIG. 3 is a block diagram illustrating the schematic constitution of the signage terminal 14. As shown in FIG. 3, in addition to the display unit 21, the printer unit 22, the camera unit 25 and the speaker unit 26, the signage terminal 14 further comprises a controller 31 for controlling the whole signage terminal 14, an operation section 32 for a user to carryout various operations, a network communication interface (IF) for carrying out communication with the information distribution server 11 via the communication network 12 and an external storage apparatus 35 for storing various data such as content data. The external storage apparatus 35 is realized by an HDD (Hard Disk Drive) or an SSD (Solid State Drive).

Herein, the controller 31 comprises an MPU (Micro Processing Unit) 36 for controlling the whole controller 31, an ROM (Read Only Memory) 37 for storing a control program for controlling the actions of the MPU 36 and an RAM (Random Access Memory) 38 for storing various data temporarily. Moreover, the controller 31 enables the MPU 36 to execute the control program stored in the ROM 37, thereby regenerating the content data distributed from the information distribution server 11 via the communication network 12 and displaying the regenerated content data on the display unit 21. In addition, the operation section 32 may consist of various switches and buttons or be integrated with the display unit 21 as a touch panel.

With the constitution above, the signage terminal 14 basically receives or acquires a plurality of preset content data as a regeneration schedule through the information distribution server 11. Moreover, the signage terminal 14 displays the advertisement information (dynamic image capturing an advertised commodity or articles introducing or describing an advertised commodity) relating to a commodity advertised as content data (hereinafter, sometimes referred to as ‘advertised commodity’) using the display unit 21 or outputs sounds introducing or describing an advertised commodity using the speaker unit 26.

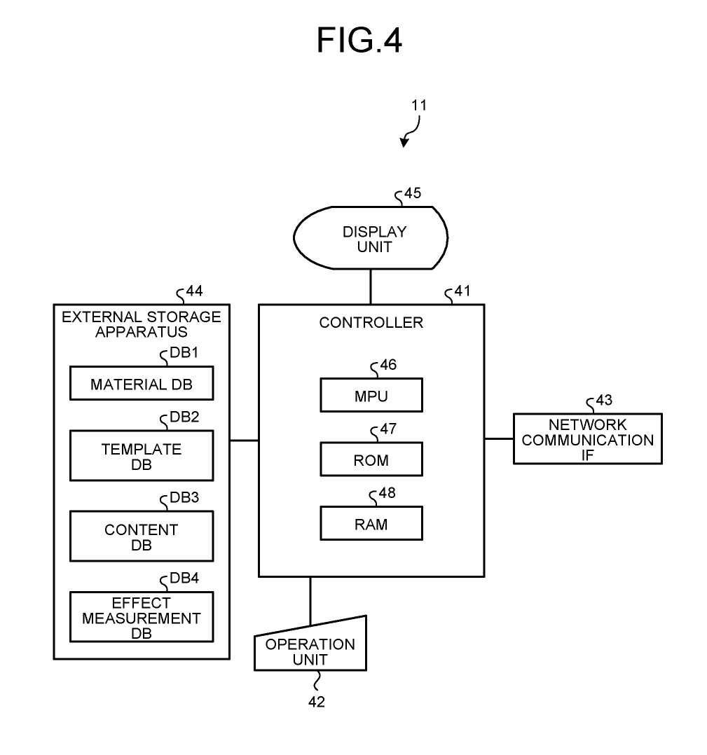

Next, the information distribution server 11 is described. FIG. 4 is a block diagram illustrating the schematic constitution of the information distribution server 11. As shown in FIG. 4, the information distribution server 11 comprises a controller 41 for controlling the whole information distribution server 11, an operation section 42 having a keyboard and a mouse for a user to carry out various operations, a network communication interface (IF) 43 for carrying out communication with the signage terminal 14 through the communication network 12, an external storage apparatus 44 for storing various data and control programs and a display unit 45 including a liquid crystal display. The external storage apparatus 44 is realized by an HDD (Hard Disk Drive) or an SSD (Solid State Drive).

Herein, the controller 41 comprises an MPU 46 for controlling the whole controller 41, an ROM 47 for storing a control program for controlling the actions of the MPU 46 and an RAM 48 for storing various data temporarily.

That is, the controller 41 controls actions of each component by enabling the MPU 46 to expand the control program stored in the ROM 47 and the external storage apparatus 44 in the RAM 48 and execute it, and moreover, controls the transmission/reception of various data such as the POS master data (commodity code, price information, commodity name information, bargain price information and bargain sale period information) between the store server 16 and the signage terminal 14 which are connected through the network communication IF 43 and the communication network 12, and the content data distributed to each signage terminal 14.

Detailed description will be given later, moreover, the controller 41 of the information distribution server 11 further determines, about the content data distributed to each signage terminal 14, whether or not the actual advertisement effect is good based on the measurement information collected during a content distribution period.

A material database DB1, a template database DB2 and a content database DB3 are stored in the external storage apparatus 44.

The material database DB1 stores the image (e.g. captured dynamic or still image of a commodity) for advertising the commodity to customers as material data in association with the commodity code of the commodity. Further, the material database DB1 stores, corresponding to the bargain sale information received from the store server 16, characters (e.g. ‘good bargain’ and the like) representing that the commodity is on bargain sale and characters (e.g. ‘100 Yen’ and the like) representing the bargain price of the commodity on bargain sale as material data.

The template database DB2 stores screen templates required to edit the content of a digital signage specialized in content of a preferential treatment project, that is, an event relating to commodity promotion.

For example, the screen template presets project category such as ‘bargain sale’, ‘clearance sale’ and the like as guidance for the controller 41 to select a screen template. In this way, by presetting project category, the controller 41 can dynamically select a screen template and carry out distribution according to the project category set in the selected screen template. Such a screen template defines the type of the information to be embedded into a part changing with the project category, and the controller 41 automatically extracts necessary information (material data in the material database DB1) from the set content and embeds the extracted information.

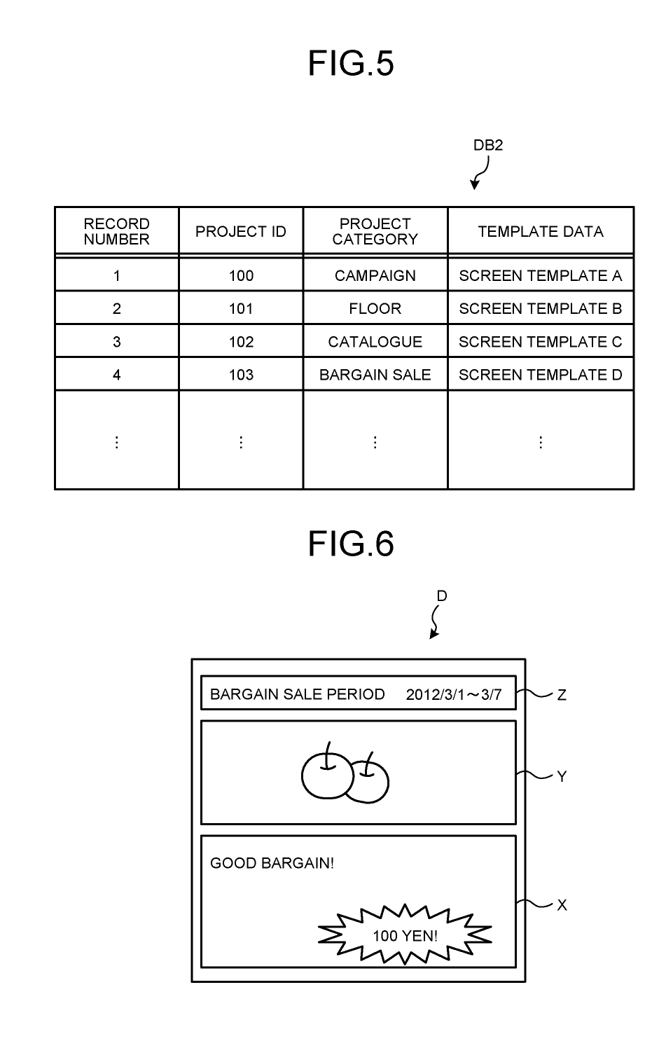

FIG. 5 is a diagram illustrating constitution of data stored in the template database DB2. As shown in FIG. 5, template data records in which the project IDs, the project categories and the template data are described in accordance with record numbers are stored in the template database DB2. A project ID is information for identifying a preferential treatment project specified by a corresponding project category.

That is, in the example shown in FIG. 5, a project ID, a project category and a screen template A of a campaign project are recorded in the record No. 1; a project ID, a project category and a screen template B of a floor project are recorded in the record No. 2; a project ID, a project category and a screen template C of a catalogue project are recorded in the record No. 3; and a project ID, a project category and a screen template D of a bargain sale are recorded in the record No. 4.

The screen template represents a screen display design displayed on the display unit 21 of the signage terminal 14 and sets the data based on a specification. The specification herein refers to a specification setting correct content data in a specified area when content data is displayed on the display unit 21 of the signage terminal 14. For example, when an XAML (a language specification for describing a user interface of an application) is used, it is set that the component name setting the material data of a content is recorded by a common component base name and an index (for example, if the base name is “Item”, then component name is Item 01, Item 02, . . . ).

For example, FIG. 6 is a schematic diagram roughly illustrating the screen template D for bargain sale. As shown in FIG. 6, an advertisement area X displaying advertisement content for a bargain sale advertisement, a commodity area Y displaying the content of a commodity on bargain sale and a period area Z displaying a bargain sale period are arranged in the screen template D.

The advertisement area X is an area displaying the name and the bargain price of a commodity on bargain sale. The commodity area Y is an area displaying the image of a commodity on bargain sale. The period area Z is an area displaying a bargain sale period.

The content database DB3 stores the content data created by the processing actions of the information distribution server 11 which will be described later.

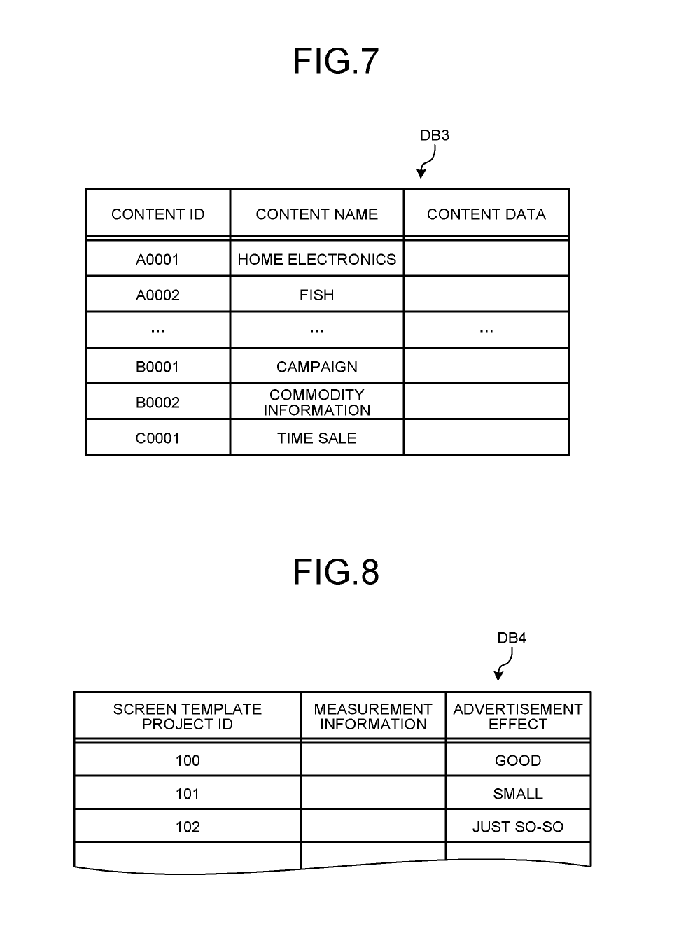

FIG. 7 is a diagram illustrating constitution of data stored in the content database DB3. As shown in FIG. 7, a content ID serving as identification information identifying the content, a content name of the content identified according to the content ID and content data identified according to the content ID are stored in the content database DB3.

Further, the external storage apparatus 44 stores an effect measurement database DB4. FIG. 8 is a diagram illustrating constitution of data stored in the effect measurement database DB4. As shown in FIG. 8, the effect measurement database DB4 stores the advertisement effect (good, just so-so, small) which will be described later together with the measurement information for the content (the project ID of the screen template used in the content) of each content datum distributed to the signage terminal 14. As an example, measurement information consists of a commodity category, a time period, meteorological information (weather, air temperature), the difference between the usual sales amount and the sales amount obtained in a content distribution period (e.g. a bargain sale period), the difference between the usual sales volume and the sales volume obtained in a content distribution period (e.g. a bargain sale period) and a customer level. Further, if meteorological information is collected as measurement information, then the meteorological information can be acquired in association with a meteorology forecast information providing service disclosed through internet. Further, the difference between the usual sales amount and the sales amount obtained in a content distribution period (e.g. a bargain sale period), the difference between the usual sales volume and the sales volume obtained in a content distribution period (e.g. bargain sale period) and the customer level can be acquired from the store server 16.

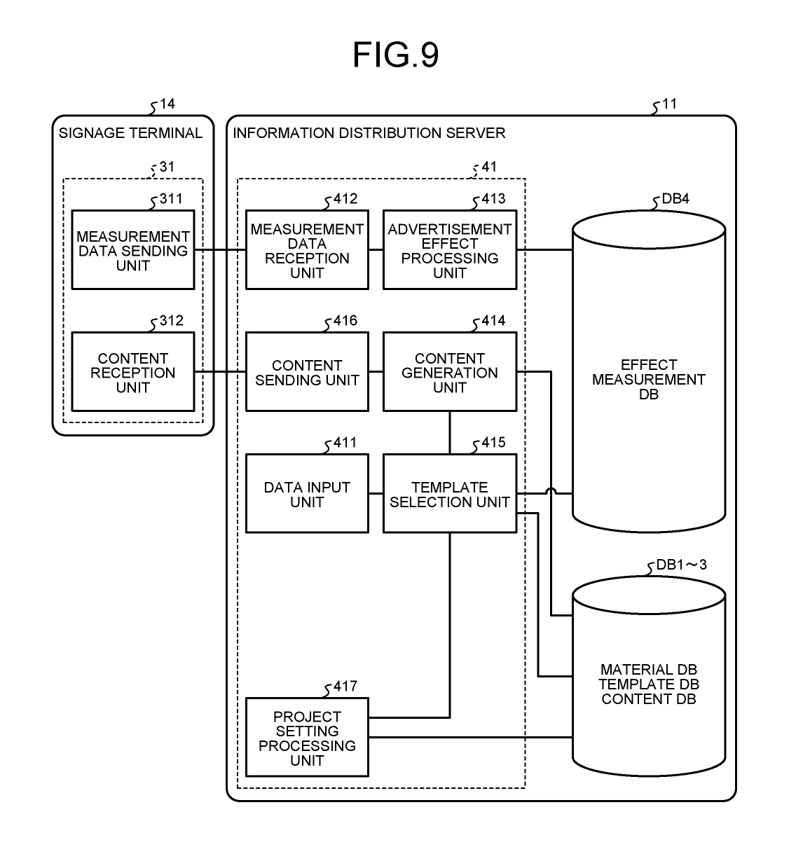

Next, functional components of the information distribution server 11 and the signage terminal 14 are described with reference to FIG. 9. FIG. 9 is a block diagram illustrating functional components of the information distribution server 11 and the signage terminal 14.

As shown in FIG. 9, by expanding the control program stored in the ROM 37 and the like in the RAM 38 and executing it, the MPU 36 of the controller 31 of the signage terminal 14 functions as a measurement data sending unit 311 and a content reception unit 312 for receiving regenerated content from the information distribution server 11.

The measurement data sending unit 311 sends the measurement information to the information distribution server 11. For example, a determination result of a customer level such as an age and sex of a viewer in front of the signage terminal 14 based on the image data captured by the camera unit 25 arranged on the signage terminal 14 and the operation history (attention degree) of the operation section 32 are sent to the information distribution server 11 as measurement information.

Next, functional components of the information distribution server 11 are described. As shown in FIG. 9, by expanding the control program stored in the ROM 47 and the external storage apparatus 44 and the like in the RAM 48 and executing it, the MPU 46 of the controller 41 of the information distribution server 11 functions as a data input unit 411, a measurement data reception unit 412, an advertisement effect processing unit 413, a content generation unit 414, a template selection unit 415, a content sending unit 416 and a project setting processing unit 417.

The data input unit 411 inputs, from the store server 16, data (project information) required for the generation of the advertisement content of a bargain sale advertisement (that is, the regeneration of advertisement content containing bargain sale information different from the advertisement content preset in a regeneration schedule) in the signage terminal 14. Herein, the project information is information including a commodity code, bargain price information, bargain sale period information and a content distribution time, as stated above.

The measurement data reception unit 412 receives the measurement information sent from the signage terminal 14 to the information distribution server 11.

The advertisement effect processing unit 413 determines whether or not the actual advertisement effect is good based on the measurement information collected in the content distribution period about the content data distributed to each signage terminal 14. The advertisement effect processing unit 413 stores the determined advertisement effect (good, just so so, small) together with the measurement information in the effect measurement database DB4 for each screen template used in the content data.

Further, since the measurement precision is low in the initial running stage of the system as information is little, in order to improve the precision, the advertisement effect processing unit 413 controls the content generation unit 414 to use different screen templates randomly or use different screen templates in a plurality of locations and distributes a plurality of content data so as to collect a great amount of measurement information. When the system has run for a specified period of time and the measurement information sufficient for an automatic analysis is stored, the information is used to determine whether or not the actual advertisement effect is good.

Further, since the measurement precision is low in the initial running stage of the system as information is little, as stated above, the advertisement effect processing unit 413 may be manually adjusted before the distribution of content data so as to interpolate the content data.

As stated above, the content generation unit 414 is controlled to use different screen templates randomly or use different screen templates in a plurality of locations and information is corrected, thereby dealing with the demand changing with the elapse of time.

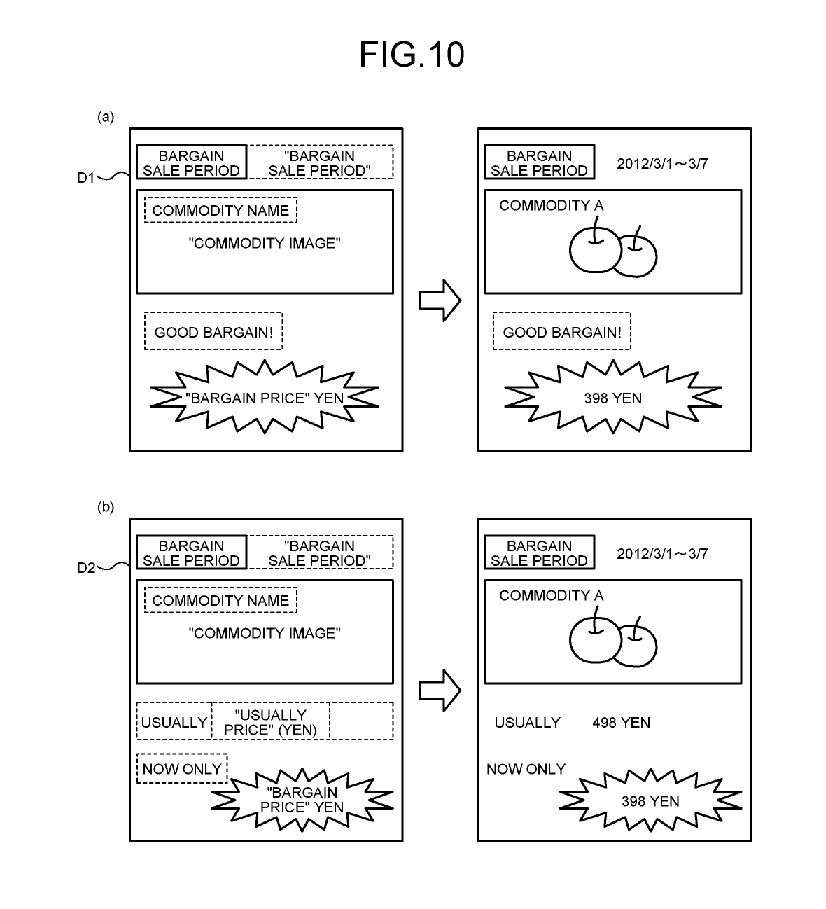

Herein, FIG. 10 is a diagram illustrating an application example of different screen templates. The example shown in FIG. 10 shows a case where the bargain sale of a commodity A is projected and usual price ‘498 Yen’ is changed to a bargain price ‘398 Yen’. In the screen template D1 shown in FIG. 10 (a), ‘bargain sale period’, ‘commodity name and commodity image’ and ‘bargain price’ are displayed as the parts changing with a bargain sale project. On the other hand, in addition to ‘bargain sale period’, ‘commodity name and commodity image’ and ‘bargain price’, ‘usual price’ and ‘price-cut amount’ obtained by calculating the difference between ‘usual price’ and ‘bargain price’ are also displayed in the screen template D2 shown in FIG. 10 (b). In this way, in the screen template D1 shown in FIG. 10 (a), ‘current price of commodity A is 398 Yen’ is distributed as content data, and in the screen template D2 shown in FIG. 10 (b), ‘commodity A, original price of which is 498 Yen, is now only 398 Yen’ is distributed as content data.

The guidance for determining whether or not advertisement effect is good includes the amount of sales increase in a content distribution carried out by changing the screen template in the same setting, or the matching between the customer level paying attention to the content data distributed in a content distribution carried out by changing the screen template in the same setting and the main customer level in the time period of content distribution (even through the sales amount is greatly increased, the expectation value is low if the customer level paying attention to the content is not matched with the customer level of the majority of customers in a specified time period).

The template selection unit 415 acquires project information relating to a project by using the data input unit 411 before the project is implemented, and preferentially selects the screen template estimated to have the best effect due to the content distribution, that is, the screen template with good advertisement effect according to the information contained in the project information with reference to the effect measurement database DB4.

Further, the determination on the selection of a screen template to be applied may be automatically made by the system, or a list of screen templates having good effect acquired according to an effect measurement result are output for a person in charge to make a determination.

The template selection unit 415 applies a screen template having a good effect for the customer level if the effect measurement database DB4 contains measurement information such as ‘female customers of 40s are more in the content distribution period designated by the information contained in the project information’. More specifically, the template selection unit 415 selects, according to the measurement information, a time period in which the object customer level are more. Next, the template selection unit 415 extracts the screen template having good effect for the specific customer level in the determined time period, and the content generation unit 414 embeds the material data of the information of the commodity which aim to expand of sales into the screen template and distributes the screen template. Moreover, the advertisement effect processing unit 413 collects measurement information within the distribution period and after the distribution period, updates advertisement effect of the screen template based on measurement information about the effect measurement database DB4.

In the case where bargain sale information (project information) is input to the data input unit 411 from the store server 16, the content generation unit 414 generates content data using the screen template which is estimated to have the best advertisement effect by the template selection unit 415, and registers the generated content data in a schedule.

Specifically, in the case where bargain sale information (project information) is input to the data input unit 411 from the store server 16, the content generation unit 414 embeds the image (e.g. captured dynamic or still image of a commodity) for advertising the subject commodity on bargain sale to customers and a telop overlaid on the image into the screen template which is estimated to have the best advertisement effect by the template selection unit 415, and generates advertisement content to be displayed on the display unit 21 of the signage terminal 14. Further, characters (“good bargain” and the like) representing that the commodity is on bargain sale and characters (“100 Yen” and the like) representing the bargain price of the commodity on bargain sale can be listed as the telop if the object commodity on bargain sale is ‘Japanese black beef 100 g’.

The content sending unit 416 displays an advertisement on the display unit 21 of the signage terminal 14.

More specifically, the content sending unit 416 distributes advertisement content corresponding to a preset regeneration schedule to the signage terminal 14 and regenerates the distributed advertisement content. Further, in the case where bargain sale information is input from the store server 16 to the data input unit 411, the content sending unit 416 distributes the advertisement content generated by the content sending unit 416 for a bargain sale advertisement instead of the advertisement content corresponding to the regeneration schedule to the signage terminal 14, thereby enabling the signage terminal 14 to carry out regeneration of the advertisement content.

Since the preset project may be changed before the implementation of the project is about to start, the project setting processing unit 417 is a unit for correcting the registered schedule. In order to secure a period of grace for correcting the schedule, the project setting processing unit 417 may set the registration period of a schedule, for example how many days since a start date of the project, how many times from a start time of the project. In this way, the person in charge can confirm the content of the registered schedule and makes a manual adjustment during the period of grace.

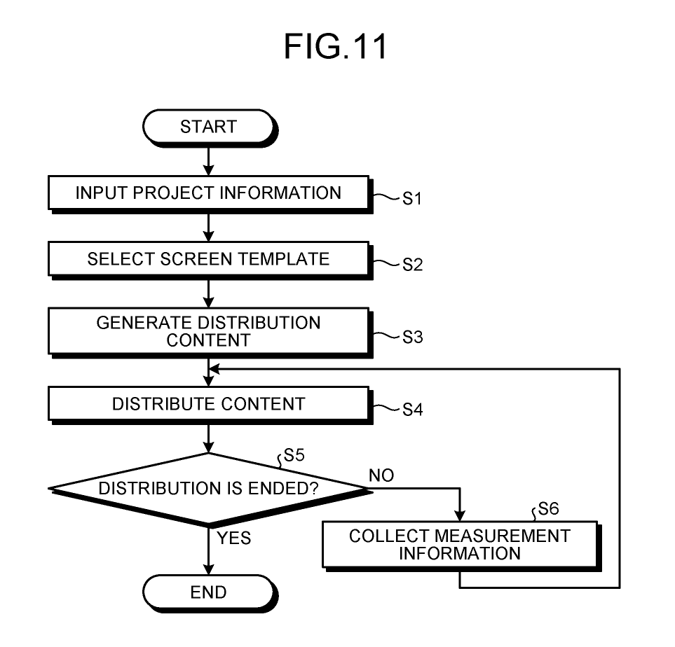

Next, the processing actions of the information distribution server 11 are described with reference to FIG. 11. FIG. 11 is a flowchart illustrating the flow of the processing actions of the information distribution server 11.

As shown in FIG. 11, in the information distribution server 11, first, the data input unit 411 inputs, from the store server 16, the bargain sale information (project information) that the necessary information such as the bargain sale period, bargain price and content distribution time and the like is set by a person in charge by selecting the project category and the object commodity (ACT S1). Further, the project information may be directly input by the person in charge to the information distribution server 11, but not input from the store server 16.

Next, the template selection unit 415 selects, from the effect measurement database DB4, the screen template estimated to have the best effect due to the content distribution based on the information contained in the project information input by the data input unit 411 (ACT S2).

Then, the content generation unit 414 embeds material data based on the project information into the screen template estimated by the template selection unit 415 to have the best effect, generates distribution content and registers the generated distribution content in the schedule (ACT S3).

Sequentially, the content sending unit 416 distributes advertisement content to the signage terminal 14 in accordance with a registered schedule when a specified time within the specified period is reached and regenerates the distributed advertisement content (ACT S4).

Moreover, the advertisement effect processing unit 413 collects the measurement information sent from the signage terminal 14 to the information distribution server 11 until the content distribution is ended (YES in ACT S5) (ACT S6).

In this way, in accordance with the present embodiment, the measurement information for measuring the advertisement effect of the content data is acquired during the distribution period in which the content data is distributed to the signage terminal to determine whether or not the advertisement effect is good, and the determined advertisement effect is stored in the effect measurement database together with the measurement information for each screen template used in the content data. Moreover, a screen template having good advertisement effect is preferentially selected based on the input project information with reference to the effect measurement database, content data is generated using the selected screen template and registered in the schedule, thus, the work starting from the selection of the screen template having the best advertisement effect using advertisement effect to the content distribution is automated, which reduces the workload of the person in charge to achieve a more effective content distribution.

Further, in the present embodiment, the signage system 10 mainly including the information distribution server 11 and the plurality of signage terminals 14 are used as a signage system, however, the present invention is not limited to this. For example, the signage terminal 14 may be used as an information display system and the processing actions executed in the information distribution server 11 may be also executed in the signage terminal 14.

The programs executed by the information distribution server 11 and the signage terminal 14 of the present embodiment are recorded in a computer-readable recording medium such as CD-ROM, flexible disk (FD), CD-R, DVD (Digital Versatile Disk) in the form of installable or executable file.

Further, the programs executed by the information distribution server 11 and the signage terminal 14 of the present embodiment may be stored in a computer connected with a network such as Internet to be provided through a network download. In addition, the programs executed by the information distribution server 11 of the present embodiment may be also provided or distributed through a network such as Internet.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An information distribution server, comprising:
a processor that executes following computer executable components stored in a memory:
a content sending unit configured to send content data to a signage terminal in accordance with a registered schedule;
a measurement data reception unit configured to receive measurement information for measuring an advertisement effect of the content data sent by the content sending unit during a content distribution period;
an advertisement effect processing unit configured to determine whether or not the advertisement effect is high with use of the measurement data collected by carrying out the content distribution, the content distribution being carried out by changing a screen template in a same setting;
an effect measurement database configured to store the advertisement effect determined by the advertisement effect processing unit together with the measurement information for each screen template used in the content data;
a data input unit configured to input a project information;
a template selection unit configured to preferentially select a screen template having a high advertisement effect based on the project information input by the data input unit with reference to the effect measurement database; and
a content generation unit configured to generate the content data using the screen template selected by the template selection unit and register the generated content data in a schedule.

2. The information distribution server according to claim 1, wherein
the advertisement effect processing unit determines, at the initial running stage, whether or not the advertisement effect is high based on the measurement information acquired by controlling the content generation unit to use different screen templates randomly to generate a plurality of pieces of the content data.

3. The information distribution server according to claim 1, wherein
the advertisement effect processing unit determines, at the initial running stage, whether or not the advertisement effect is high based on the measurement information acquired by controlling the content generation unit to use different screen templates in a plurality of locations to generate a plurality of pieces of the content data.

4. An information distribution method, comprising:
sending content data to a signage terminal in accordance with a registered schedule;
receiving measurement information for measuring the advertisement effect of the content data sent by a content sending unit during a content distribution period;
determining, by a processor, whether or not advertisement effect is high with use of the measurement data collected by carrying out the content distribution, the content distribution being carried out by changing a screen template in a same setting;
inputting specified project information;
preferentially selecting a screen template having a high advertisement effect based on the project information input by a data input unit with reference to the effect measurement database in which the advertisement effect determined by an advertisement effect processing unit is stored together with the measurement information for each screen template used in the content data; and
generating the content data using the screen template selected by a template selection unit and registering the generated content data in a schedule.

5. The method according to claim 4, wherein
the determining determines, at the initial running stage, whether or not the advertisement effect is high based on the measurement information acquired by controlling a content generation unit to use different screen templates randomly to generate a plurality of pieces of the content data.

6. The method according to claim 4, wherein
the determining determines, at the initial running stage, whether or not the advertisement effect is high based on the measurement information acquired by controlling a content generation unit to use different screen templates in a plurality of locations to generate a plurality of pieces of the content data.
